(19) United States
(12) Patent Application Publication
(10) Pub. No.: US 2025/0148886 A1
(43) Pub. Date: May 8, 2025

(54) SYSTEMS AND METHODS FOR LIGHT-BASED TAMPER DETECTION IN POINT-OF-SALE DEVICES

(71) Applicant: VeriFone, Inc., Wilmington, DE (US)

(72) Inventor: Gary Stuart Burns, Hebden Bridge (GB)

(73) Assignee: VeriFone, Inc., Wilmington, DE (US)

(21) Appl. No.: 18/730,213

(22) PCT Filed: Jan. 20, 2022
(86) PCT No.: PCT/US2022/013152

§ 371 Date: Jul. 18, 2024

(51) Int. Cl. G07G 3/00

(52) U.S. Cl. CPC G07G 3/003

(57) ABSTRACT

A point-of-sale device, including a tamper detection circuit, a processor, and a memory is provided. The tamper detection circuit includes a light sensor. The light sensor includes a phototransistor. The tamper detection circuit is configured to provide a light detection signal based on incident light received by the light sensor. The processor is configured to generate a tamper signal based on the light detection signal. The processor is further configured to initiate a tamper event response according to the tamper signal. The tamper event response may erase a memory or trigger an alarm. The point-of-sale device further includes a substantially opaque internal housing. The internal housing may be substantially opaque. The tamper detection circuit, the processor, and the memory may be arranged within the internal housing.

### FIELD OF THE DISCLOSURE

The present disclosure is directed generally to systems, devices, and methods for light-based tamper detection in point-of-sale devices.

### BACKGROUND

Point-of-sale devices are used in a variety of environments to process payment transactions. While processing payment transactions, the point-of-sale devices receive, process, and/or store a wide array of sensitive information, such as credit card information, debit card information, banking information, customer personal identification numbers (PINs), and more. This sensitive information makes the point-of-sale devices a target for tampering.

Existing point-of-sale devices employ a number of tamper detection systems and methods based on breaking connections formed by electrical connectors during a tampering event. These connectors are often formed by metal domes or elastomeric connectors requiring pressure of the assembled point-of-sale device case to hold them onto pads on a surface of a PCB. Breaking such a connection causes an open circuit in the tamper detection circuit, triggering tamper detection. However, contamination, distortion of the case, and environmental effects (such as temperature, vibration, shock, etc.) can, in some cases, cause these connectors to trigger false tampers. Tamper detection will immediately prevent further operation of the point-of-sale device, as well as erase the memory of the device, permanently disabling the point-of-sale device. Thus, false tamper detection results in unnecessarily disabled point-of-sale devices, customer dissatisfaction, and costly product returns to the manufacturer. Accordingly, there is a need for tamper detection systems and methods with greater resistance to false tamper detection.

### SUMMARY OF THE DISCLOSURE

The present disclosure provides systems, devices, and methods for light-based tamper detection in point-of-sale devices. A tamper detection circuit is arranged within a point-of-sale device. The tamper detection circuit includes a light sensor with one or more photosensitive components. The tamper detection circuit is configured to provide a light detection signal corresponding to incident light received by the light sensor. The light detection signal is received by a processor. The processor evaluates the light detection signal to determine if a tamper event has occurred. If the processor determines that a tamper event has occurred, the processor generates a tamper signal. The processor further uses the tamper signal in a tamper event response, such as erasing a memory storing sensitive information or triggering an alarm.

Generally, in one aspect, a point-of-sale device is provided. The point-of-sale device includes a tamper detection circuit. The tamper detection circuit includes a light sensor. The light sensor may include a phototransistor, a photoresistor, or a photodiode. The tamper detection circuit may be a static line circuit or a switched line circuit.

The tamper detection circuit is configured to provide a light detection signal. The light detection signal is based on incident light received by the light sensor. The incident light may have a wavelength between approximately 400 and 700 nm.

The point-of-sale device further includes a processor. The processor is configured to generate a tamper signal based on the light detection signal. In one example, the tamper signal is generated based on threshold level. In this example, the light detection signal exceeding a threshold level indicates a tamper event.

The processor is further configured to initiate a tamper event response according to the tamper signal. In one example, the tamper event response erases at least a portion of a memory. In another example, the tamper event response triggers an alarm. The processor may be further configured to process payment transactions. The memory may be configured to store payment information.

According to an example, the point-of-sale device further includes an internal housing. The internal housing may be substantially opaque. The tamper detection circuit is arranged within the internal housing. Further, the processor and/or the memory may be arranged within the internal housing. Additionally, one or more traces electrically coupled to one or more user inputs may be arranged within the internal housing. The user input may be a touchscreen or a keypad.

According to an example, the point-of-sale device further includes a connector tamper detection circuit. The connector tamper detection circuit includes one or more conductive elastomeric connectors. The one or more conductive elastomeric connectors are embedded within the internal housing. The connector tamper detection circuit is configured to provide a connector disruption signal to the processor. The connector disruption signal is based on a change in a size, a shape, or a position of at least one of the one or more conductive elastomeric connectors. The processor is further configured to generate the tamper signal based on the connector disruption signal.

Generally, in another aspect, a method for detecting a tamper event in a point-of-sale device is provided. The method includes (1) measuring, via a light detection circuit included as part of a tamper detection circuit, an amount of light received by the light detection circuit; (2) determining, by a processor associated with the tamper detection circuit, whether the measured amount of light exceeds a threshold level such that the measured amount of light indicates a tamper event; (3) generating, by the processor, a tamper signal in response to the determination; and (4) erasing, via the processor, a memory based on the tamper signal.

According to another example, the method further includes (1) providing 510 providing a connector disruption signal, wherein the connector disruption signal is based on a change in a size, a shape, or a position of at least one of the one or more conductive elastomeric connectors within an internal housing of the point-of-sale device; (2) receiving, via the processor, the connector disruption signal; (3) generating, via the processor, the tamper signal based on the connector disruption signal. The tamper detection circuit may be arranged within the internal housing. The internal housing may be substantially opaque.

In various implementations, a processor or controller may be associated with one or more storage media (generically referred to herein as “memory,” e.g., volatile and non-volatile computer memory such as RAM, PROM, EPROM, EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a front view of a point-of-sale device, in accordance with an example.

FIG. 2 is a flow diagram of a system for light-based tamper detection, in accordance with an example.

FIG. 3 is a layout diagram of a point-of-sale device, in accordance with an example.

FIG. 4 is a layout diagram of a point-of-sale device with an internal housing, in accordance with an example.

FIG. 5 is a layout diagram of an internal housing of a point-of-sale device, in accordance with an example.

FIG. 6 is a flowchart of a method for detecting a tamper event in a point-of-sale device, in accordance with an example.

FIG. 7 is a flowchart of a method for detecting a tamper event in a point-of-sale device, in accordance with a further example.

### DETAILED DESCRIPTION OF EMBODIMENTS

The present disclosure provides systems, devices, and methods for light-based tamper detection in point-of-sale devices. These systems, devices, and methods determine if a tamper event has occurred based on light received by internal components of a point-of-sale device. A tamper detection circuit is arranged within the point-of-sale device, and can be configured as a static line circuit or a switched-line circuit. The tamper detection circuit includes a light sensor with one or more photosensitive components, such as one or more phototransistors, photoresistors, and/or photodiodes. The tamper detection circuit is configured to provide a light detection signal corresponding to incident light, such as visible light having a wavelength between 400 nanometers and 700 nanometers, received by the light sensor. For example, the current and/or voltage of the light detection signal may be directly proportional to the amount of incident light received by the light sensor.

The light detection signal is received by a processor, such as a processor configured to process payment transactions. The processor then evaluates the light detection signal to determine if a tamper event, such as an unauthorized individual damaging or disassembling the point-of-sale device, has occurred. This evaluation may compare the current and/or voltage of the light detection signal to a threshold level. If the processor determines that a tamper event has occurred, the processor generates a tamper signal, and uses the tamper signal to initiate a tamper event response. In some cases, the tamper event response erases a memory storing sensitive information, such as payment information, preventing the sensitive information from being compromised. In other examples, the tamper event response triggers an alarm. Unlike the mechanical tamper detection systems described above, these light-based detection systems are not susceptible to false tampers due to environmental effects such as temperature, vibration, and shock.

In one configuration, the tamper detection circuit is arranged inside an internal housing of the point-of-sale device, also referred to as a “bunker.” The internal housing is made of a substantially opaque material, such that detectable amounts of visible light do not penetrate the internal housing. Thus, the tamper detection circuit will only detect incident light if the internal housing has experienced a tamper event, such as damaging or disassembling the internal housing. In this example, the processor and memory are also arranged within the internal housing. Accordingly, accessing the processor and/or memory requires tampering with the internal housing, thereby causing the tamper detection circuit to receive visible light and communicate with the processor to erase the memory. In a further example, the internal housing may also enclose circuitry (such as circuit traces) electrically coupled to one or more user inputs, such as a touchscreen or a keypad, thereby restricting access to the user inputs.

The internal housing may include an additional tamper detection aspect in the form of one or more conductive elastomeric connectors. The conductive elastomeric connectors, such as Zebra® strips, can be embedded within the internal housing in a compressed manner. If a tamper event occurs physically damaging the internal housing, one or more of the conductive elastomeric connectors can decompress, creating an open circuit and triggering the processor to erase the memory.

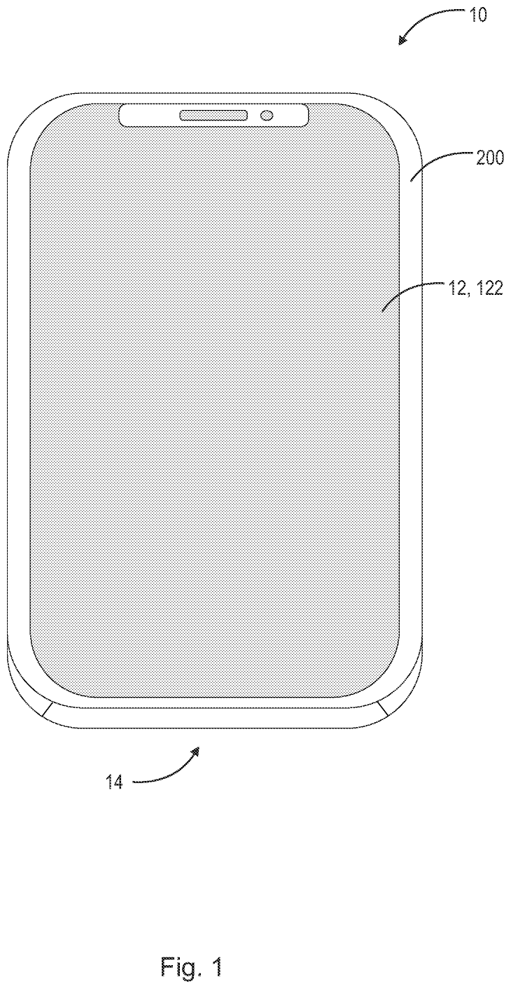

FIG. 1 illustrates an example point-of-sale device 10 embodied as a mobile point-of-sale terminal. However, in other examples, the point-of-sale device 10 may be embodied as a fixed or mounted point-of-sale terminal, a fixed or mounted point-of-sale device, a fixed or portable kiosk, a mobile device (such as a smartphone or tablet computer), or a gas pump point-of-sale terminal or kiosk. The point-of-sale device 10 includes, among other aspects and components, an external housing 200, a user input 122 embodied as a touchscreen 12, and a card slot 14. Generally, the point-of-sale device 10 is configured to collect payment information 130 from a user, such as a patron at a retail or dining establishment. Payment information 130 may be broadly defined to include any information related to the processing of a payment. The payment information 130 may be collected by a user's payment card (such as a credit card or debit card) being inserted into the card slot 14 or by a user interface displayed on the touchscreen 12. In further examples, the payment information 130 may correspond to alternative payment methods, such as PayPal®, Stripe®, Apple Pay®, Google Pay®, Alipay®, Klarna.®, PaySafeCard®, cryptocurrency, etc.

The point-of-sale device 10 may then process the payment information 130, and then convey the processed or collected payment information 130 to a network or a payment processor. In turn, the point-of-sale device 10 may receive data related to the payment information 130 from the network or payment processor. The network may be a local area network (LAN), a wide area network (WAN), a 3G network, a 4G/LTE network, or may include a plurality of devices and/or services connected over the Internet. Connections between the network and the point-of-sale device 10 can include both wired and wireless connections. The payment processor may be a third-party processor (such as a party other than the user of the card, the business establishment, or the provider of the point-of-sale device 10) that receives payment information from users and performs or handles the financial transaction between the source of funds of the user and the destination of the funds, such as the bank of the business establishment.

The external housing 200 may be made from various materials including plastics, metals, glass, or any combination thereof. In a preferred example, the materials composing the external housing 200 are substantially opaque, thus shielding internal components of the point-of-sale device 10 from incident light 110 upon the point-of-sale device 10. The incident light 110 may be generated by a variety of sources, such as any variety of lighting fixtures or portable lights (such as a flashlight), or even the sun and stars. The touchscreen 12 may be liquid crystal, light emitting diode (LED), organic LED, or other display with touch-screen functionality. The touchscreen 12 may display a user interface to receive additional payment information 130 from the user, such as a user's personal identification number (PIN) or telephone number. The card slot 14 is configured to receive a user's card, such as a credit card, debit card, gift card, or alternative payment card. In a further example, the point-of-sale device 10 may include additional user inputs 122, such as a keypad, keyboard, mouse, sensor, camera, optical scanner, or any other practical input device.

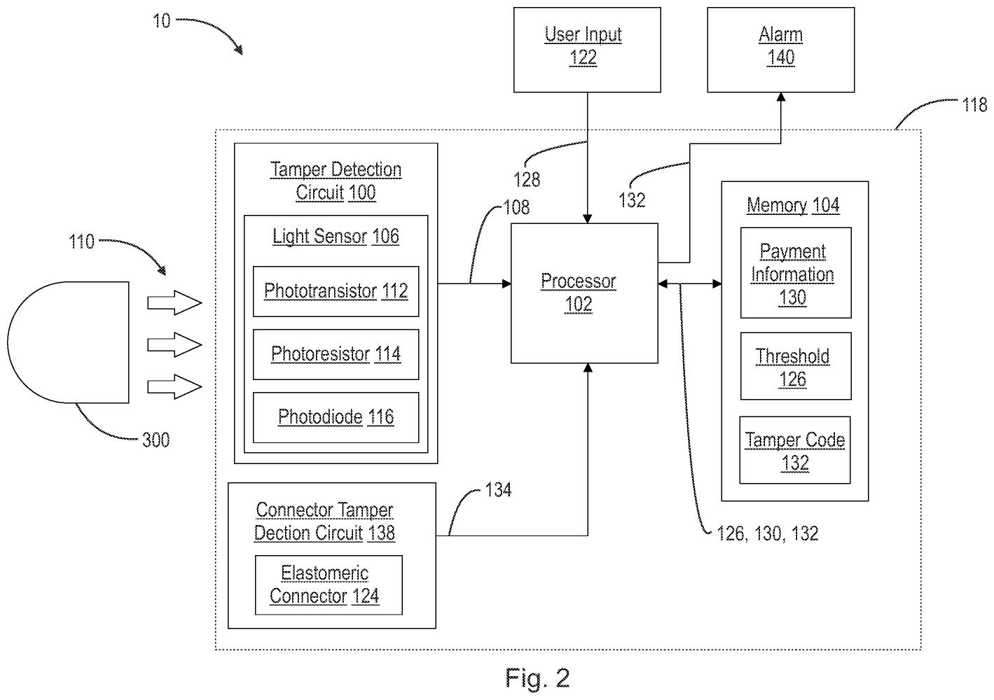

FIG. 2 illustrates a functional block diagram of a system for securing the payment information 130 stored within a point-of-sale device 10. The point-of-sale device 10 includes a tamper detection circuit 100, a processor 102, and a memory 104. The tamper detection circuit 100 includes a light sensor 106. The light sensor 106 is configured to translate incident light 110, such as incident light 110 from a lamp 300, into an electrical signal. In a preferred example, the light sensor 106 includes a phototransistor 112 to translate the incident light 110 with a wavelength between about 400 nanometers and 700 nanometers to an electrical signal. The phototransistor 112 is preferred due to low current draw in a “dark” state, thus preserving battery life of any batteries powering the point-of-sale device 10. In this example, a collector terminal of the phototransistor 112 may be coupled to a voltage supply source, while an emitter terminal of the phototransistor may be electrically coupled (directly or indirectly) to the output of the light sensor 106. Depending on the configuration of the tamper detection circuit 100, the voltage and current output of the phototransistor 112 may be proportional to the amount of received incident light 110.

In further examples, the light sensor 106 may use one or more photoresistors 114 and/or photodiodes 116 to convert the incident light 110 to an electrical signal. The output of the light sensor 106 may be further processed (through amplification, filtering, etc.) to generate a light detection signal 108 representative of the incident light 110 received by the light sensor 106.

In one example, the tamper detection circuit 100 may be configured as a static line circuit. In this example, the light detection signal 108 generated by the tamper detection circuit 100 has a constant voltage proportional to the incident light 110 received by the light sensor 106. Alternatively, the tamper detection circuit 100 may be configured as a switched line circuit. In this example, the voltage of the light detection signal 108 switches or oscillates between a high voltage level and a low voltage level (such as 0 V) as driven by the processor 102. The switching between high and low voltage levels may occur based on a clock signal generated by a clock circuit of the point-of-sale device 10. The switched line circuit provides enhanced security over the static line circuit, as the static line circuit may be circumvented by externally biasing the output of the tamper detection circuit 100. In one example, the light detection signal 108 generated by a switched line circuit is pulled to a low voltage level when the incident light 110 upon the light sensor 106 exceeds a threshold level 126.

The light detection signal 108 generated by the tamper detection circuit 100 is provided to the processor 102. In one example, the processor 102 may be the only processing unit of the point-of-sale device 10, and thus performs all of the processing necessary for the point-of-sale device 10 to function, such as processing payment transactions. In other example, the point-of-sale device 10 includes several processing units, and the processor 102 of FIG. 2 is specifically configured as a security processing unit to process inputs received from the tamper detection circuit 100 and other security components.

The processor 102 evaluates the light detection signal 108 against a threshold level 126 to determine if a tamper event has occurred. The threshold level 126 may be stored in memory 104 and retrieved by the processor 102 to perform the evaluation. Alternatively, the threshold level 126 may be programmed directly into the processor 102. If the light detection signal 108 exceeds the threshold level 126, the processor 102 then generates a tamper signal 132. In some examples, the light detection signal 108 must exceed the threshold level 126 for a predetermined period of time, such as several milliseconds, for the processor 102 to generate the tamper signal 132. Requiring the light detection signal 108 to exceed the threshold level 126 for a predetermined period of time protects against falsely detecting tampers triggered by anomalous events. Further, the threshold level 126 may be adjusted according to the desired sensitivity of the point-of-sale device 10 to incident light 110. For instance, the threshold level 126 may be lowered for increased sensitivity, or raised for decreased sensitivity.

The processor can then use the tamper signal 132 to initiate one or more tamper event responses. In one example, the processor 102 provides the tamper signal 132 to memory 104. Upon receipt of the tamper signal 132, at least a portion of the memory 104 is erased. As with the processor 102, the memory 104 of FIG. 2 may be the only memory unit of the point-of-sale device 10, and thus storing all of the data necessary for the point-of-sale device 10 to function.

In other examples, the point-of-sale device 10 includes several memory units, and the memory 104 of FIG. 2 is specifically configured as a secure memory unit to store payment information 130 and/or other sensitive information captured and/or generated by the point-of-sale device 10. This payment information 130 may include card information (account numbers, expiration dates, security codes, etc.), user information (birth dates, PINs, digital signatures, etc.), bank information (corresponding to the banks of the user and/or the payment processor), and more. The payment information 130 may correspond in part to user input data 128 received from a user input 122, such as a touchscreen 12.

In one example, all data stored in the memory 104 is erased upon receiving the tamper signal 132. In this example, clearing all data stored in memory 104 either resets or disables the point-of-sale device 10. In other examples, only payment information 130 is erased from memory 104 upon receiving the tamper signal 132. Alternatively, rather than erase the payment information 130, the memory 104 encrypts the payment information 130 upon receiving the tamper signal 132. The data of memory 104 erased by the tamper signal 132 may be selected by programming the processor 102.

In another example, the tamper event response may be to trigger an alarm 140 with the tamper signal 132. The alarm 140 may be incorporated into the point-of-sale device 10 and generate an audible, visual, or haptic response indicative of a tamper event. In other examples, the alarm 140 may generate an alarm signal to be transmitted, via wired and/or wireless connections, to the proprietor of the business using the point-of-sale device 10, as well as any relevant authorities, such as police or private security.

In an even further example, the tamper event response may include storing a tamper code 142 in memory 104. The tamper code 142 may be indicative of various properties of the tamper event, such as type of tamper detected (incident light, open circuit connector, etc.), time of tamper, and/or tamper event response initiated (erasing sensitive memory, playing audible alarm, transmitting alarm signal to proprietor, etc.).

It should be appreciated that the light sensor 106 will only receive a significant amount of incident light 110 if the point-of-sale device 10 has experienced a tamper event, such as damage to or disassembly of aspects of the point-of-sale device 10. For example, and as described above, the external housing 200 of the point of sale device 10 is preferably opaque, thus shielding the light sensor 106 from incident light 110. However, if the external housing 200 is disassembled and opened, the light sensor 106 may no longer be shielded. Accordingly, the tamper detection circuit 100 will then generate light detection signal 108 proportional to the incident light 110, and the processor 102 will evaluate the light detection signal 108 to determine if portions or all of the memory 104 should be erased. In some examples, the decision to erase all of the memory 104, rather than a certain portion of the memory 104 (such as payment information 130) may be programmed into the processor 102 prior to the detection of the tamper event. In some examples, the processor 102 may be configured to erase all of the data stored in memory 104, thus rendering the point-of-sale device 10 inoperable. In further examples, the processor 102 may be configured to erase all of the data stored in memory 104 except for programs and data required for a factory reset (such as a bootloader). In even further examples, the processor 102 may be configured to only erase sensitive data, such as payment information 130.

In another example, and as illustrated in FIG. 2, the tamper detection circuit 100, the processor 102, and the memory 104 may be arranged within an internal housing 118 inside the external housing 200. Like the external housing 200, the internal housing 118 may be a substantially opaque plastic shell shielding the aforementioned components from incident light 110. Accordingly, in this example, a tamper event must disassemble or damage both the external housing 200 and the internal housing 118 to trigger the processor 102 to erase memory 104. In this example, the processor 102 and memory 104 are arranged proximate to the tamper detection circuit 100, ensuring that any attempt to tamper with the payment information 130 stored in memory 104 will require enough incident light 110 on the tamper detection circuit 100 to trigger the processor 102 to erase memory 104.

Further, one or more conductive elastomeric connectors 124 may be embedded within the internal housing 118. The one or more conductive elastomeric connectors 124 are part of a connector tamper detection circuit 138. Tampering with the internal housing 118 may cause the embedded conductive elastomeric connectors 124 to deform, compress, decompress or otherwise change size, shape, and/or position, leading to an open circuit, short circuit, or other disruption in the connector tamper detection circuit 138. This disruption causes the connector tamper detection circuit 138 to provide a connector disruption signal 134 to the processor 102. Upon receiving the connector disruption signal 134, the processor generates the tamper signal 132 to erase the memory 104. Thus, conductive elastomeric connectors 124 may be used to provide an additional mode of tamper protection.

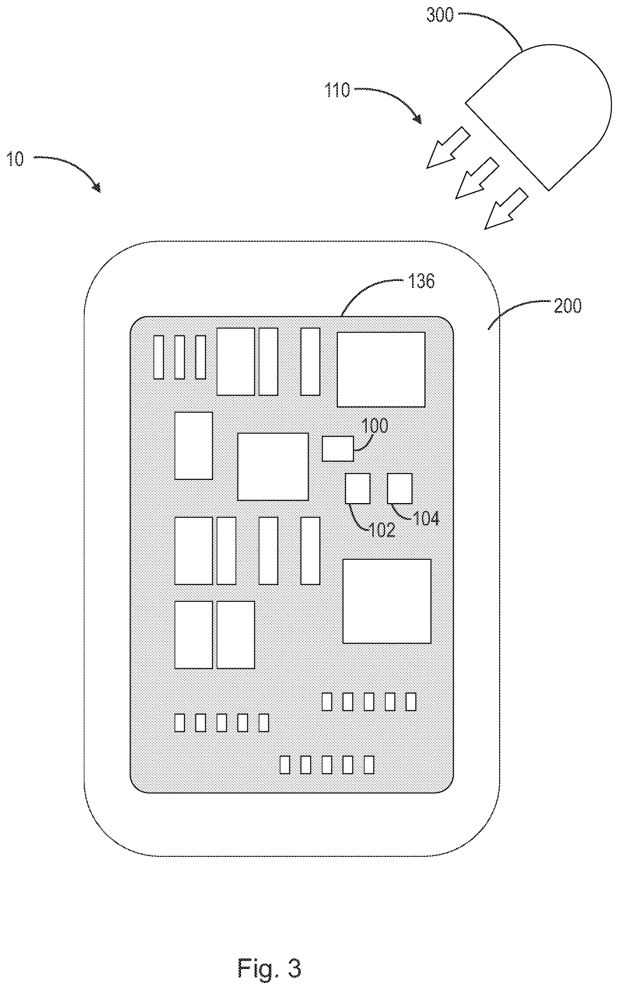

FIG. 3 illustrates an example layout of a point-of-sale device 10. In this example layout, a number of components (integrated circuits, discrete components, etc.) are arranged on a printed circuit board (PCB) 136, including tamper detection circuit 100, processor 102, and memory 104. The PCB 136 is arranged within external housing 200. Thus, if the external housing 200 is opened, the tamper detection circuit 100 will receive incident light 110, and trigger the processor 102 to erase the memory 104.

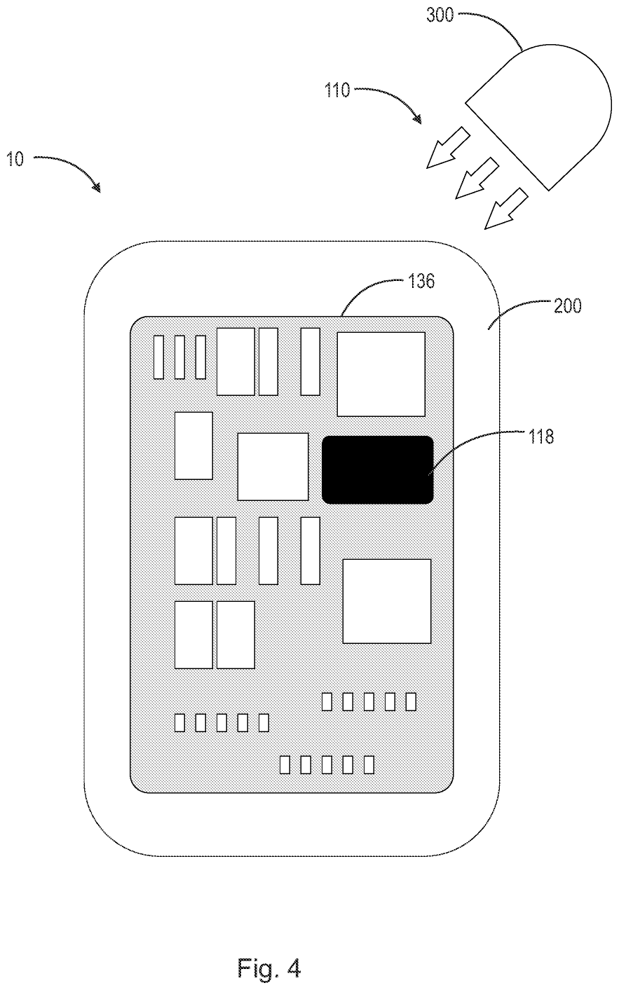

In a further example, FIG. 4 illustrates a layout wherein the tamper detection circuit 100, the processor 102, and the memory 104 are enclosed within internal housing 118. Therefore, both the external housing 200 and the internal housing 118 must be opened to trigger the processor 102 to erase the memory 104, thereby reducing the chance of false tamper detections.

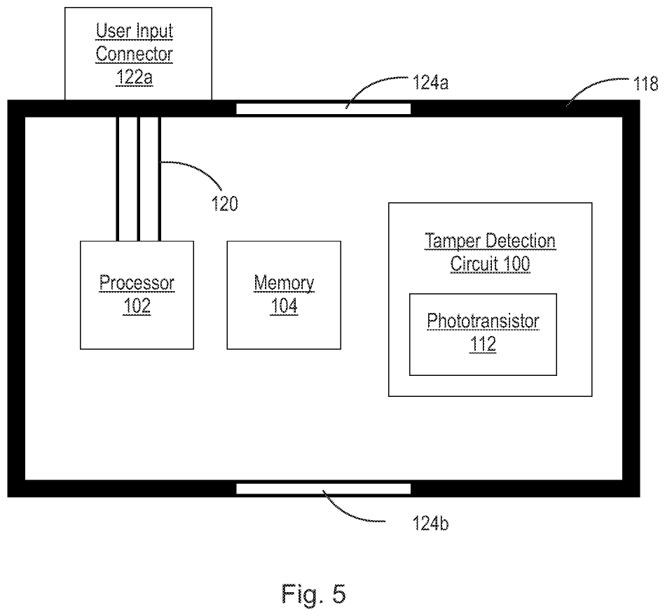

FIG. 5 illustrates an example layout of internal housing 118. As shown, the internal housing 118 encloses processor 102, memory 104, and tamper detection circuit 100 with a substantially opaque plastic shell. The phototransistor 112 is shown as being included with the tamper detection circuit 100. Further, conductive elastomeric connectors 124a, 124b are embedded in the sides of the internal housing 118 to provide a second mode of tamper detection. Further, the internal housing also surrounds traces 120 electrically coupling a user input connector 122a to the memory 104. The user input connector 122a provides an interface between a user input 122, such as a touchscreen or keypad, and traces 120, to convey user input data 128 to the memory 104.

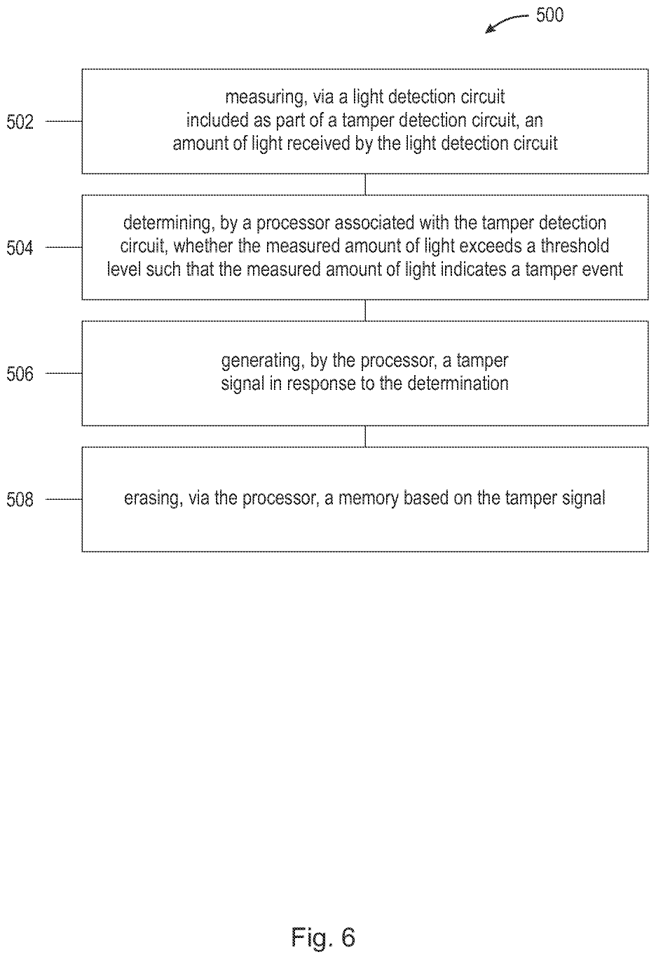

FIG. 6 is a flowchart of a method 500 for detecting a tamper event in a point-of-sale device. The method 500 includes (1) measuring 502, via a light detection circuit included as part of a tamper detection circuit, an amount of light received by the light detection circuit; (2) determining 504, by a processor associated with the tamper detection circuit, whether the measured amount of light exceeds a threshold level such that the measured amount of light indicates a tamper event; (3) generating 506, by the processor, a tamper signal in response to the determination; and (4) erasing 508, via the processor, a memory based on the tamper signal.

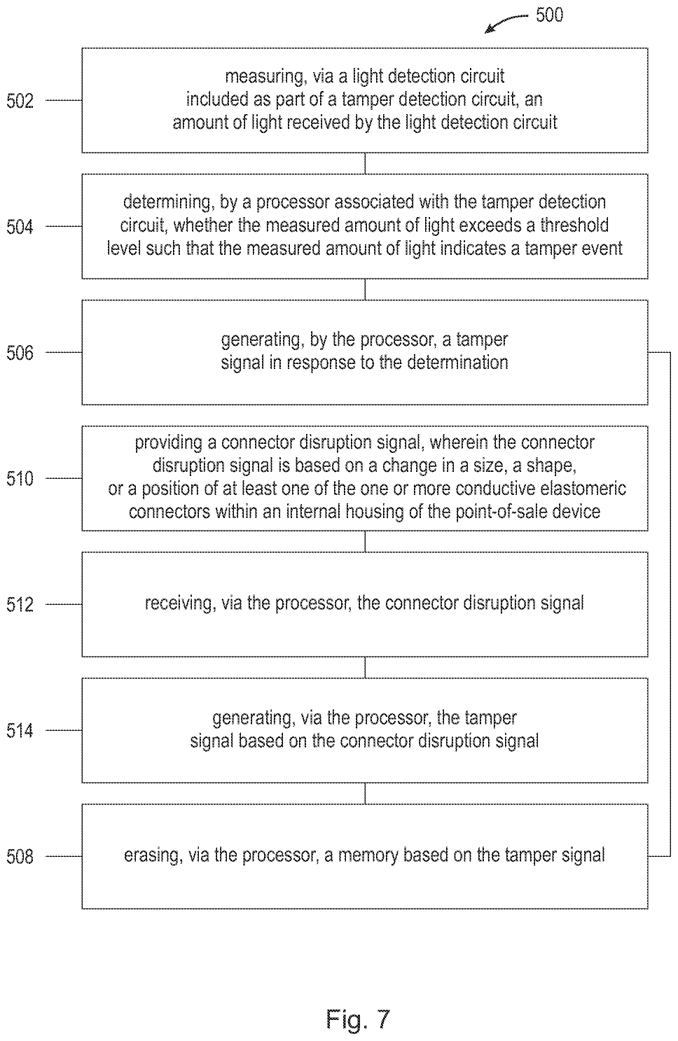

FIG. 7 is a further flowchart of a method 500 for detecting a tamper event in a point-of-sale device. The method 500 further includes (1) providing 510 a connector disruption signal, wherein the connector disruption signal is based on a change in a size, a shape, or a position of at least one of the one or more conductive elastomeric connectors within an internal housing of the point-of-sale device; (2) receiving 512, via the processor, the connector disruption signal; (3) generating 514, via the processor, the tamper signal based on the connector disruption signal. The tamper detection circuit may be arranged within the internal housing. The internal housing may be substantially opaque.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A point-of-sale device, comprising:
a tamper detection circuit comprising a light sensor, wherein the tamper detection circuit is configured to provide a light detection signal based on incident light received by the light sensor; and
a processor configured to:
generate a tamper signal based on the light detection signal; and
initiate a tamper event response according to the tamper signal.

2. The point-of-sale device of claim 1, wherein the tamper event response erases at least a portion of a memory.

3. The point-of-sale device of claim 1, wherein the tamper event response triggers an alarm.

4. The point-of-sale device of claim 1, wherein the light sensor comprises a phototransistor, a photoresistor, or a photodiode.

5. The point-of-device of claim 1, wherein the tamper signal is generated further based on a threshold level, wherein the light detection signal exceeding the threshold indicates a tamper event.

6. The point-of-sale device of claim 1, wherein the incident light has a wavelength between approximately 400 and 700 nm.

7. The point-of-sale device of claim 1, further comprising an internal housing.

8. The point-of-sale device of claim 7, wherein the internal housing is substantially opaque.

9. The point-of-sale device of claim 7, wherein the tamper detection circuit is arranged within the internal housing.

10. The point-of-sale device of claim 7, wherein the processor and/or the memory are arranged within the internal housing.

11. The point-of-sale device of claim 7, wherein one or more traces electrically coupled to one or more user inputs are arranged within the internal housing.

12. The point-of-sale device of claim 11, wherein the user input is a touchscreen or keypad.

13. The point-of-sale device of claim 7, further comprising a connector tamper detection circuit comprising one or more conductive elastomeric connectors embedded within the internal housing.

14. The point-of-sale device of claim 13, wherein the connector tamper detection circuit is configured to provide a connector disruption signal to the processor, wherein the connector disruption signal is based on a change in a size, a shape, or a position of at least one of the one or more conductive elastomeric connectors.

15. The point-of-sale device of claim 14, wherein the processor is further configured to generate the tamper signal based on the connector disruption signal.

15. The point-of-sale device of claim 1, wherein the tamper detection circuit is a static line circuit or a switched line circuit.

16. The point-of-sale device of claim 1, wherein the processor is configured to process payment transactions.

17. The point-of-sale device of claim 1, wherein the memory is configured to store payment information.

18. A method for detecting a tamper event in a point-of-sale device, comprising:
measuring, via a light detection circuit included as part of a tamper detection circuit, an amount of light received by the light detection circuit;
determining, by a processor associated with the tamper detection circuit, whether the measured amount of light exceeds a threshold level such that the measured amount of light indicates a tamper event;
generating, by the processor, a tamper signal in response to the determination; and
erasing, via the processor, a memory based on the tamper signal.

19. The method of claim 18, further comprising:
providing a connector disruption signal, wherein the connector disruption signal is based on a change in a size, a shape, or a position of at least one of the one or more conductive elastomeric connectors within an internal housing of the point-of-sale device;
receiving, via the processor, the connector disruption signal; and
generating, via the processor, the tamper signal based on the connector disruption signal.

20. The method of claim 19, wherein the tamper detection circuit is arranged within the internal housing, wherein the internal housing is substantially opaque.
